(19) United States
(12) Patent Application Publication
(10) Pub. No.: US 2016/0055216 A1
(43) Pub. Date: Feb. 25, 2016

(54) INFORMATION PROCESSING DEVICE AND INFORMATION PROCESSING METHOD THEREOF

(71) Applicants: Fu Tai Hua Industry (Shenzhen) Co., Ltd., Shenzhen (CN); HON HAI PRECISION INDUSTRY CO., LTD., New Taipei (TW)

(72) Inventor: DAN CAO, Shenzhen (CN)

(21) Appl. No.: 14/734,555

(22) Filed: Jun. 9, 2015

(30) Foreign Application Priority Data
Aug. 21, 2014 (CN) 201410414133.3

(51) Int. Cl. G06F 17/30

(52) U.S. Cl. CPC G06F 17/30528; G06F 17/30339; G06F 17/30401

(57) ABSTRACT

An information processing method includes steps of obtaining one or more kinds of information in any kind of computer data, extracting a feature from the obtained information and determining at least one feature word which corresponds to the extracted feature, according to a relationship table. In response to user operation, at least one determined feature word can be changed. The target content can be searched according to at least one changed feature word.

### CROSS-REFERENCE TO RELATED APPLICATION

This application claims priority to Chinese Patent Application No. 201410414133.3 filed on Aug. 21, 2014, the contents of which are incorporated by reference herein.

### FIELD

The subject matter herein generally relates to information processing technology, and particularly to an information processing method, system, and device.

### BACKGROUND

When searching a target word or idea via an electronic device, such as a mobile phone, a user should input one or more query terms, such as one or more words. Nowadays, the user also can input pictures or geographic locations as the query term to search, however, the user cannot change or optimize search results.

### BRIEF DESCRIPTION OF THE DRAWINGS

Implementations of the present technology will now be described, by way of example only, with reference to the attached figures.

FIG. 1 is a block diagram of an information processing device of one embodiment.

FIG. 2 is a diagrammatic view showing a relationship table recording relationships between features and feature words, stored in a storage device of the information processing device of FIG. 1.

FIG. 3 is a flowchart illustrating an information processing method of one embodiment.

FIG. 4 is a flowchart illustrating an information processing method of another embodiment.

FIG. 5 is a flowchart illustrating additional steps of the information processing method of FIG. 4.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

By way of summary, at least some embodiments of the invention maintain a relational table between features and feature words. Features are elements typically found in information, such as web pages or stored materials; a displayed map is a non-limiting example of such information, and a feature could be a landmark on the map. When the feature is selected from the information, any corresponding feature words are retrieved from the table. Searches can then be performed on the feature words.

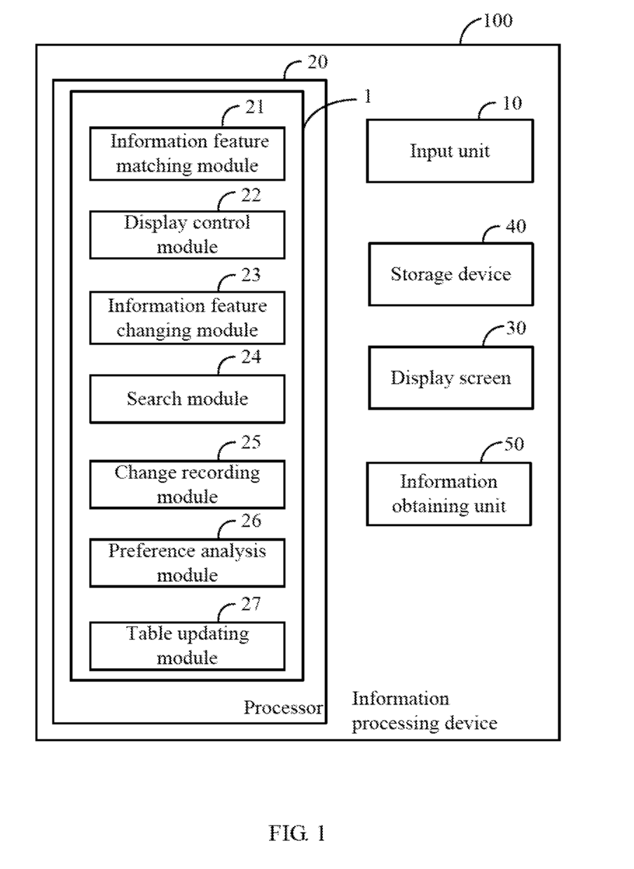

FIG. 1 illustrates an information processing device 100. The information processing device 100 includes an input unit 10, a processor 20, a display screen 30, a storage device 40, and an information obtaining unit 50. In one embodiment, the input unit 10 can be a keyboard, a touch pad, or the like. The display screen 30 can be a liquid crystal display screen, an electronic ink display screen, and the like. In another embodiment, the input unit 10 can combine with the display screen 30 as a touch screen. The information processing device 100 can be a tablet computer, a mobile phone, a workstation computer, or a personal computer including a desktop computer and a portable computer.

The information obtaining unit 50 is used to obtain one or more kinds of information. The one or more kinds of information include pictorial data, video data, time data, temperature data, luminance data, and location data. In the embodiment, the information obtaining unit 50 includes a number of hardware units, such as a camera, a clock unit, a temperature sensor, a light sensor, an audio sensor, and a global positioning system (GPS) unit. The camera captures the pictorial or video data. The clock unit is used to provide the time data in real time. The temperature sensor obtains the temperature data. The light sensor obtains the luminance data. The GPS unit is used to locate the information processing device 100 to determine location data of the information processing device 100. The audio sensor can be a microphone and is used to obtain audio data.

In the embodiment, the information obtaining unit 50 obtains the information in response to user operations via the input unit 10. For example, in one embodiment, when a user want to search for a target content via a search bar (not shown) displayed on the display screen 30, the search bar may include a number of different data items, such as a picture item, an audio item, a temperature item, a luminance item, and a geographical item. The processor 20 can activate the corresponding hardware unit in response a selection. For example, the processor 20 can activate the light sensor to obtain luminance data in response to a selection of the luminance item, to enable the input of luminance data.

As shown in FIG. 1, an information processing system 1 stored in the storage device 40 and executed by the processor 20 is illustrated. The information processing system 1 includes an information feature matching module 21, a display control module 22, an information feature changing module 23, a search module 24, a change recording module 25, a preference analysis module 26, and a table updating module 27. The modules of the information processing system 1 can be a collection of software instructions stored in the storage device 40 and executed by the processor 20, or can include separated functionalities represented by hardware or integrated circuits, or as software and hardware combinations, such as a special-purpose processor or a general-purpose processor with special-purpose firmware.

In at least one embodiment, the processor 20 can be a central processing unit, a digital signal processor, or a single chip. In at least one embodiment, the storage device 40 can be an internal storage system, such as a flash memory, a random access memory (RAM) for temporary storage of information, and/or a read-only memory (ROM) for permanent storage of information. The storage device 40 can also be a storage system, such as a hard disk, a storage card, or a data storage medium. The storage device 40 can include volatile and/or non-volatile storage devices. In at least one embodiment, the storage device 40 can include two or more storage devices such that one storage device is a solid state memory and the other storage device is a hard drive. Additionally, one or more of the storage devices 40 can be located either entirely or partially external relative to the information processing device 100.

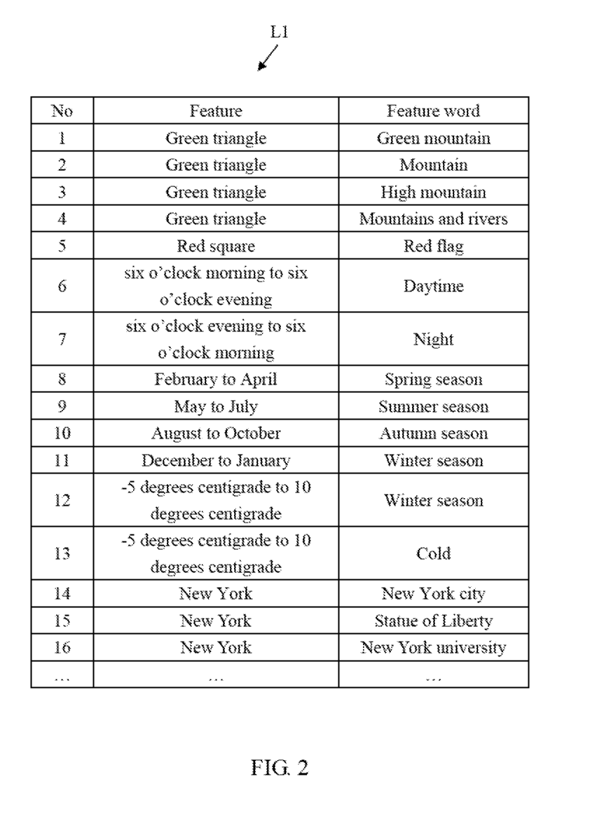

Referring also to FIG. 2, the information feature matching module 21 is used to extract a feature from the information obtained by the information obtaining unit 50, and determine at least one word corresponding to the extracted feature (hereinafter “feature word”). In detail, the information feature matching module 21 obtains the one or more kinds of information, extracts the feature included in the information, and determines a feature word corresponding to the extracted feature, according to a relationship table L1 as shown in FIG. 2. As shown in FIG. 2, the relationship table L1 records relationships between features and feature words. For example, in the relationship table L1, the feature “green triangle” corresponds to feature words “green mountain”, “mountain”, “mountains and rivers” and the like. The feature “red square” corresponds to a feature word “red flag”, the feature “six o'clock morning to six o'clock evening” corresponds to a feature word “daytime”, and the feature “six o'clock evening to six o'clock morning” corresponds to a feature word “night.”

In another embodiment, the information is not limited to that obtained by the information obtaining unit 50, but also can be information and data including information which is stored in the storage device 40 or received from other electronic devices.

In the embodiment, when the information is the pictorial data, the information feature matching module 21 extracts the feature, such as color or texture of the pictorial data according to a picture analysis technology, such as a histograms of oriented gradients algorithm, a scale invariant feature transform algorithm, and other applicable algorithms. The information feature matching module 21 then obtains the at least one feature word matching with the feature, according to the relationship table L1.

When the information is the location data of the information processing device 100, the information feature matching module 21 obtains a geographical location from the location data and takes the geographical location as the feature. The information feature matching module 21 then determines the feature word corresponding to the geographical location according to the relationship table. For example, if the geographical location are equivalent to or match “New York”, the information feature matching module 21 then determines at least one feature word corresponding to “New York” as being “New York city”, “Statue of Liberty”, or “New York university”, according to the relationships recorded in the relationship table L1.

When the information is time data including date and time, the information feature matching module 21 obtains the date and time as the feature, and determines at least one feature word corresponding to the date and time according to the relationships recorded in the relationship table L1. As shown in FIG. 2, in relationship table L1, there are a number of relationships between different dates and times, and corresponding feature words. For example, February to April corresponds to spring season, May to July corresponds to summer season, August to October corresponds to autumn season, and December to January corresponds to the winter season.

When the information is the temperature data, the information feature matching module 21 obtains the temperature value as the feature, and determines at least one feature word corresponding to the temperature value, according to the relationships recorded in the relationship table L1. For example, the information feature matching module 21 determines feature words corresponding to a temperature value of between −5 degrees centigrade and 10 degrees centigrade as “winter,” “cold,” or the like.

The display control module 22 controls the display screen 30 to display the at least one feature word determined by the information feature matching module 21.

The information feature changing module 23 can change the at least one feature word determined by the information feature matching module 21 in response to user operation. In detail, when the user is not satisfied with the at least one feature word determined by the information feature matching module 21, the user can input at least one new feature word via the input unit 10. The information feature changing module 23 then changes the at least one feature word determined by the information feature matching module 21 to the at least one new feature word input by user, thus obtaining at least one changed feature word. In one embodiment, when an amount of the at least one feature word determined by the information feature matching module 21 is greater than 1, the information feature changing module 23 also changes the several feature words to one particular and preferred feature word selected from the several feature words, in response to a selection operation by the user.

The display control module 22 also controls the display screen 30 to display the at least one changed feature word.

The search module 24 is used to search for content according to the at least one changed feature word. In detail, the search module 24 searches for content which is related to the at least one changed feature word, and can arrange the contents found as a result of search according to degree of relation between the contents and the at least one changed feature word. In the embodiment, the search module 24 can search for the related content from the storage device 40 of the information processing device 100, or from Internet, or from a local area network, etc. If the user does not change the least one feature word determined by the information feature matching module 21, the search module 24 searches the contents according to the at least one feature word determined by the information feature matching module 21. In another embodiment, the search module 24 always searches the contents according to the at least one feature word determined by the information feature matching module 21 notwithstanding that the user changes the at least one feature word determined by the information feature matching module 21.

In the embodiment, the contents can be texts, webpages, videos, music, pictures, and the like.

The change recording module 25 associates the at least one changed feature word with the feature extracted by the information feature matching module 21, and record a relationship between the feature and the at least one changed feature word to form one recorded relationship.

For example, when the information changing module 23 changes the feature words “green mountain”, “mountain”, and “mountains and rivers,” which correspond to the feature “green triangle,” to “green mountains and rivers”, the change recording module 25 associates the feature word “green mountains and rivers” with the feature “green triangle”, and records a relationship between the “green mountains and rivers” and “green triangle” to form one recorded relationship.

The preference analysis module 26 is used to calculate a number of repetitions of each recorded relationship recorded by the change recording module 25, and determines whether the number of repetitions of one recorded relationship is greater than a predetermined value, such as 2 times. If the number of repetitions of one recorded relationship is greater than the predetermined value, the preference analysis module 26 determines the recorded relationship as a study record. In the embodiment, the preference analysis module 26 determines the recorded relationship with the same content (such as the relationship between the feature and the at least one changed feature word being recorded), and calculates the number of times that the recorded relationship with the same content is repeated.

The table updating module 27 updates the relationship table L1 according to the study record. In detail, the table updating module 27 obtains the feature and the at least one changed feature word of the study record, and obtains the same feature as specified in the study record from the relationship table L1, and changes the feature words of that feature of the relationship table L1 to the at least one changed feature word of the study record, thus updating the relationship table L1.

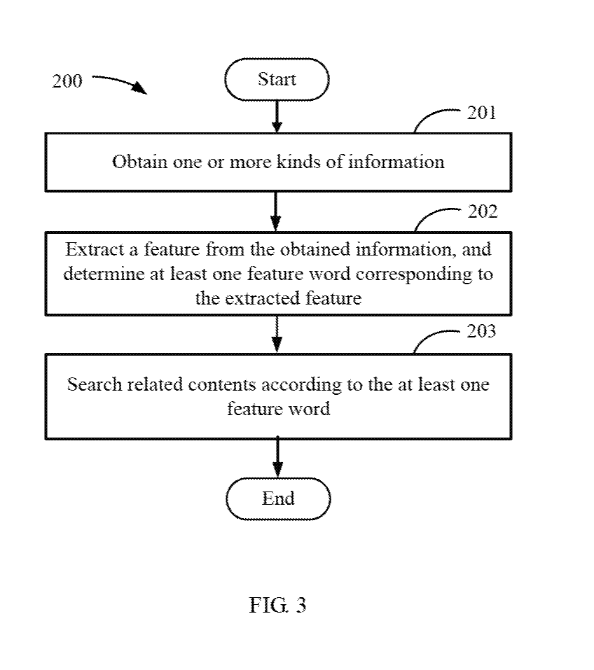

FIG. 3 illustrates a flowchart of an information processing method 200 of one embodiment. The method 200 is provided by way of example, as there are a variety of ways to carry out the method. The method 200 described below can be carried out using the configurations illustrated in FIG. 1, for example, and various elements of these figures are referenced in explaining the example method. Each block shown in FIG. 3 represent one or more processes, methods, or subroutines carried out in the example method. Additionally, the illustrated order of blocks is by example only and the order of the blocks can be changed. The example method can begin at block 201.

At block 201: obtaining one or more kinds of information, the one or more kinds of information include pictorial data, video data, time data, temperature data, luminance data, and location data. In one embodiment, the one or more kinds of information are provided by an information obtaining unit of an image processing device. In another embodiment, the one or more kinds of information can be data stored in the image processing device.

At block 202: extracting feature from the obtained information, and determining at least one feature word corresponding to the extracted feature.

At block 203: searching related contents according to the at least one feature word.

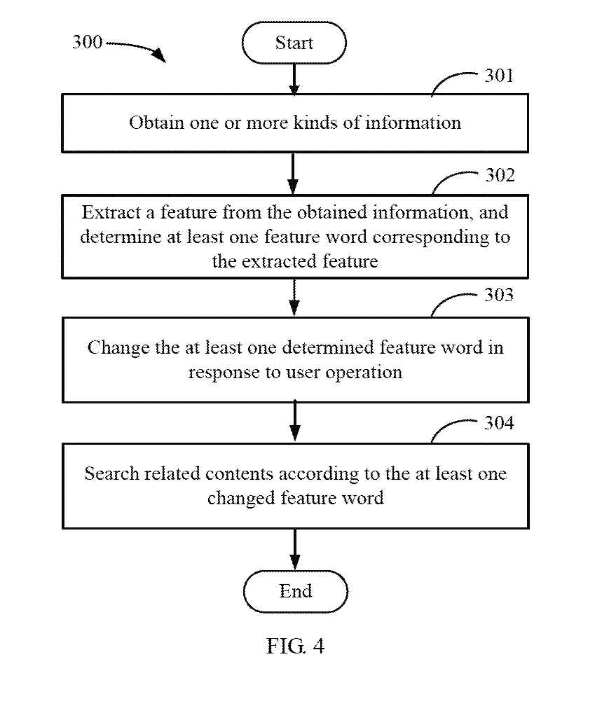

FIG. 4 illustrates a flowchart of an information processing method 300 of another embodiment. The method 300 is provided by way of example, as there are a variety of ways to carry out the method. The method 300 described below can be carried out using the configurations illustrated in FIG. 1, for example, and various elements of these figures are referenced in explaining the example method. Each block shown in FIG. 4 represent one or more processes, methods, or subroutines carried out in the example method. Additionally, the illustrated order of blocks is by example only and the order of the blocks can be changed. The example method can begin at block 301.

At block 301: obtaining one or more kinds of information, the one or more kinds of information include pictorial data, video data, time data, temperature data, luminance data, and location data. In one embodiment, the one or more kinds of information are provided by an information obtaining unit of an image processing device. In another embodiment, the one or more kinds of information can be data stored in the image processing device.

At block 302: extracting a feature from the obtained information, and determining at least one feature word corresponding to the extracted feature.

At block 303: changing the at least one determined feature word in response to user operation. In detail, block 303 includes: changing the at least one determined feature word to the at least one new feature word input by the user via an input unit or changing the at least one determined feature word to one particular and preferred feature word selected from the several feature words, in response to a selection operation by the user.

At block 304: searching related contents according to the at least one changed feature word.

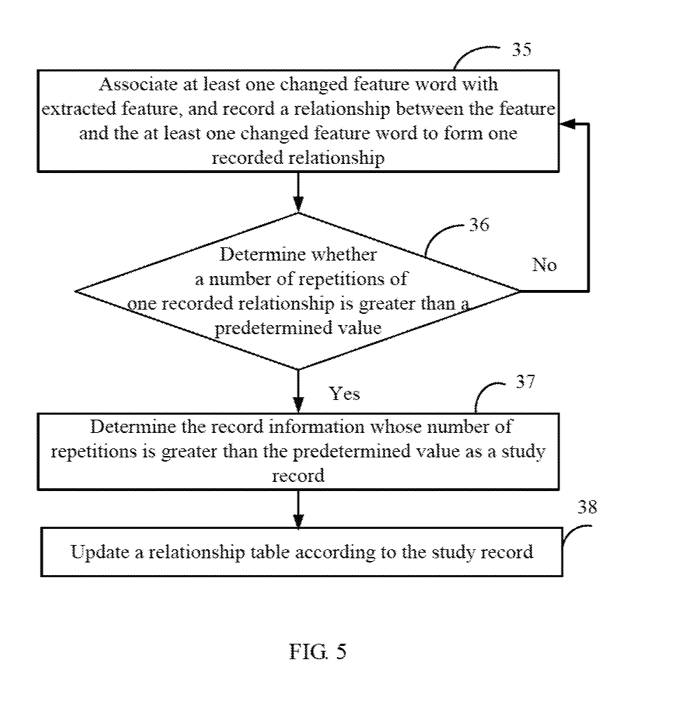

FIG. 5 shows a flowchart illustrating additional steps of the information processing method of FIG. 4. The method is provided by way of example, as there are a variety of ways to carry out the method. The method described below can be carried out using the configurations illustrated in FIG. 1, for example, and various elements of these figures are referenced in explaining the example method. Each block shown in FIG. 5 represent one or more processes, methods, or subroutines carried out in the example method. Additionally, the illustrated order of blocks is by example only and the order of the blocks can be changed. The example method can begin at block 35.

At block 35: associating the at least one changed feature word with the extracted feature, and recording a relationship between the feature and the at least one changed feature word to form one recorded relationship.

At block 36: calculating a number of repetitions of each recorded relationship, and determining whether the number of repetitions of one recorded relationship is greater than a predetermined value. If yes, the process jumps to block 37, else, return to block 35.

At block 37: determining the recorded relationship whose number of repetitions is greater than the predetermined value as a study record.

At block 38: updating a relationship table according to the study record.

According to the image processing device 100, the methods 200 and 300, the present disclosure can extract feature from the information, and obtain the feature words corresponding to the feature, and search the related content according to the feature words. Furthermore, the present disclosure can change the feature words corresponding to the feature according to user's habit automatically, and then search the related content according to the changed feature word.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An information processing method comprising:
obtaining one or more kinds of information;
extracting a feature from the obtained information, and determining at least one feature word corresponding to the extracted feature according to a relationship table;
changing the at least one determined feature word in response to user operation; and
searching related contents according to the at least one changed feature word or the determined at least one feature word corresponding to the extracted feature.

2. The method according to claim 1, further comprising:
associating the at least one changed feature word with the extracted feature, and recording a relationship between the feature and the at least one changed feature word to form one recorded relationship;
calculating a number of repetitions of each recorded relationship and determining whether the number of repetitions of one recorded relationship is greater than a predetermined value;
determining the recorded relationship as a study record if the number of repetitions of the recorded relationship is greater than the predetermined value; and
updating the relationship table according to the study record.

3. The method according to claim 2, wherein the step of updating the relationship table according to the study record comprises:
obtaining the feature and the at least one changed feature word of the study record;
obtaining the same feature as specified in the study record from the relationship table; and
changing the feature words of that feature of the relationship table to the at least one changed feature word of the study record, thus updating the relationship table.

4. The method according to claim 1, wherein the step of changing the at least one determined feature word in response to user operation comprises:
changing the at least one determined feature word to at least one new feature word input by a user via an input unit or changing the at least one determined feature word to one particular and preferred feature word selected from the several feature words, in response to a selection operation by the user.

5. The method according to claim 1, wherein the step of determining at least one feature word corresponding to the extracted feature according to a relationship table comprises:
determining at least one feature word corresponding to the extracted feature according to relationships between a plurality of features and feature words recorded in the relationship table.

6. An information processing device comprising:
a storage device storing a relationship table and a plurality of modules; and
at least one processor configured to execute the plurality of modules, the plurality of modules comprising:
an information feature matching module configured to, upon execution by the at least one processor, cause the at least one processor to extract a feature from one or more kinds of information and determine at least one feature word corresponding to the extracted feature according to the relationship table;
an information feature changing module configured to, upon execution by the at least one processor, cause the at least one processor to change the at least one feature word determined by the information feature matching module in response to user operation; and
a search module configured to, upon execution by the at least one processor, cause the at least one processor to search contents according to the at least one changed feature word or the at least one feature word determined by the information feature matching module.

7. The device according to claim 6, further comprising:
a change recording module configured to, upon execution by the at least one processor, cause the at least one processor to associate the at least one changed feature word with the feature extracted by the information feature matching module, and record a relationship between the feature and the at least one changed feature word to form one recorded relationship;
a preference analysis module configured to, upon execution by the at least one processor, cause the at least one processor to calculate a number of repetitions of each recorded relationship recorded by the change recording module, determine whether the number of repetitions of one recorded relationship is greater than a predetermined value, and determine the recorded relationship as a study record if the number of repetitions of the recorded relationship is greater than the predetermined value; and
a table updating module configured to, upon execution by the at least one processor, cause the at least one processor to update the relationship table according to the study record.

8. The device according to claim 7, wherein the table updating module updates the relationship table according to the study record comprises:
obtaining the feature and the at least one changed feature word of the study record;
obtaining the same feature as the feature as specified in the study record from the relationship table; and
changing the feature words of that feature of the relationship table to the at least one changed feature word of the study record, thus updating the relationship table.

9. The device according to claim 6, wherein the information feature changing module changes the at least one determined feature word in response to user operation comprises: changing the at least one determined feature word to at least one new feature word input by a user via an input unit or changing the at least one determined feature word to one particular and preferred feature word selected from the several feature words, in response to a selection operation by the user.

10. The device according to claim 6, wherein the information feature matching module determines at least one feature word corresponding to the extracted feature according to relationships between a plurality of features and feature words recorded in the relationship table.

11. A computer implemented information processing method comprising:
maintaining a relationship table of a plurality of features and corresponding feature words;
obtaining one or more kinds of information;
selecting a feature within the obtained information;
identifying whether the selected feature is in the relationship table;
retrieving, in response to a positive result of the identifying, at least one of the corresponding feature words;
searching for information on the selected feature by using the retrieved at least one corresponding feature word;
extracting a feature from the obtained information, and determining at least one feature word corresponding to the extracted feature according to the relationship table;
changing the at least one determined feature word in response to user operation; and
searching related contents according to the at least one changed feature word or the determined at least one feature word corresponding to the extracted feature.

12. The method according to claim 11, further comprising:
associating the at least one changed feature word with the extracted feature, and recording a relationship between the feature and the at least one changed feature word to form one recorded relationship;
calculating a number of repetitions of each recorded relationship and determining whether the number of repetitions of one recorded relationship is greater than a predetermined value;
determining the recorded relationship as a study record if the number of repetitions of the recorded relationship is greater than the predetermined value; and
updating the relationship table according to the study record.

13. The method according to claim 12, wherein the step of updating the relationship table according to the study record comprises:
obtaining the feature and the at least one changed feature word of the study record;
obtaining the same feature as specified in the study record from the relationship table; and
changing the feature words of that feature of the relationship table to the at least one changed feature word of the study record, thus updating the relationship table.

14. The method according to claim 11, wherein the step of changing the at least one determined feature word in response to user operation comprises:
changing the at least one determined feature word to at least one new feature word input by a user via an input unit or changing the at least one determined feature word to one particular and preferred feature word selected from the several feature words, in response to a selection operation by the user.

15. The method according to claim 11, wherein the step of determining at least one feature word corresponding to the extracted feature according to the relationship table comprises:
determining at least one feature word corresponding to the extracted feature according to relationships between a plurality of features and feature words recorded in the relationship table.
